(19) United States
(12) Patent Application Publication
(10) Pub. No.: US 2025/0041777 A1
(43) Pub. Date: Feb. 6, 2025

(54) AIR-TREATMENT SYSTEM FOR A UTILITY VEHICLE

(71) Applicant: KNORR-BREMSE Systeme für Nutzfahrzeuge GmbH, München (DE)

(72) Inventors: Andreas Leinung, München (DE); Karsten Schnittger, München (DE)

(21) Appl. No.: 18/836,812

(22) PCT Filed: Jan. 26, 2023
(86) PCT No.: PCT/EP2023/051891

§ 371 Date: Aug. 8, 2024

(30) Foreign Application Priority Data
Feb. 9, 2022 (DE) 10 2022 103 014.8

(51) Int. Cl. B01D 46/00; B01D 53/26; B60R 16/08; B60T 17/00

(52) U.S. Cl. CPC B01D 46/009; B01D 53/26; B01D 2257/80; B01D 2258/06; B01D 2259/4566; B01D 2279/40; B60R 16/08; B60T 17/004

(57) ABSTRACT

An air-treatment system for a utility vehicle, comprising at least one air-treatment unit and at least one air-dryer cartridge, detachably screwed onto the air-treatment unit, wherein the air-dryer cartridge has an identification element on an outer side of the air-dryer cartridge and the air-treatment unit has a counterpart for the identification element wherein, in the assembled position, the identification element and the counterpart for the identification element are arranged substantially in a direct line-of-sight connection.

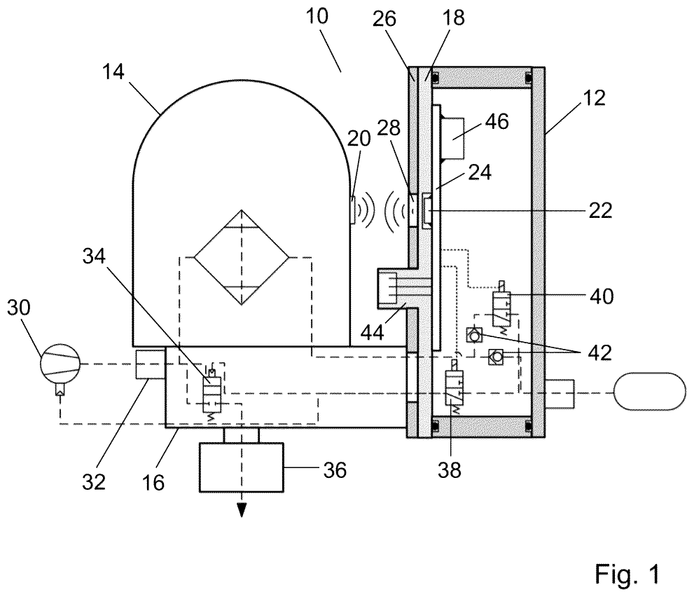

### BACKGROUND AND SUMMARY

The present invention relates to an air-treatment system for a utility vehicle, comprising at least one air-treatment unit and at least one air-dryer cartridge detachably screwed onto the air-treatment unit and having a corresponding identification means.

The correct association between spare parts or replacement parts in the form of air-dryer cartridges and prevention of the installation of low-value, already used or counterfeit air-dryer cartridges is already the subject of the prior art.

Thus, DE 10 2010 038 064 A1 has already disclosed an air-treatment unit having an air-dryer cartridge by means of which it is possible to avoid a situation where the air-treatment unit is operated with an incorrect air-dryer cartridge. For this purpose, the air-dryer cartridge has an indication member which enters into interaction with a receiver member of the air-treatment unit, thus enabling the type of air-dryer cartridge to be identified in an automated manner.

DE 10 2005 050 635 A1 furthermore discloses an air-filter cartridge for mounting on an air-treatment device of a utility vehicle. According to the invention, it is envisaged that the air-filter cartridge has identification means, the information content of which can be acquired by an acquisition device. The invention furthermore relates to a method for detecting properties of an air-filter cartridge.

In addition, DE 10 2009 011 824 A1 discloses a system having an air-treatment unit and an air-filter cartridge for mounting on the air-treatment unit, wherein the air-filter cartridge has an identification means comprising a memory, and wherein the information content in the memory can be acquired and modified by the acquisition device.

Moreover, EP 2 229 994 A2 relates to a seal component comprising a seal body that has a first seal surface for sealing a volume to be sealed. The seal body at least partially surrounds an electronic component. An operating method for a seal component comprises the following steps: supplying a seal component according to the invention, changing information in an electronic memory of the seal component, interrogating the information from the electronic memory of the seal component, evaluating the interrogated information and performing an action in accordance with and/or taking into account an evaluation result of the evaluation of the interrogated information.

EP 1 849 672 A2 furthermore discloses a cartridge for a compressed-air-treatment unit on a motor vehicle or utility vehicle. According to the invention, a sensor, by means of which, for example, a moisture content of a means of treating the compressed air, in particular granules, is monitored, is arranged in the cartridge. In accordance with the signal from the sensor, automatic switching between a compressed-air-treatment circuit and a regeneration circuit takes place in a control device.

In addition, DE 10 2008 012 699 A1 discloses an air-filter cartridge for mounting on a compressed-air-treatment unit in a vehicle, wherein a sensor for detecting a moisture content and a transponder having an antenna and a memory are arranged in the air-filter cartridge. According to the invention, provision is made for the transponder to be coupled to the sensor.

Moreover, DE 10 2007 044 586 A1 discloses a control unit for identifying spare parts for subsystems in a vehicle having information read in by an acquisition device. According to the invention, it is envisaged that the control unit has at least one interface for at least one acquisition device and at least one interface for direct or indirect connection to several subsystems. The invention furthermore relates to a system and to a method for identifying spare parts for subsystems in a vehicle.

Furthermore, EP 1 985 351 A1 discloses a filter device, preferably for use in a motor vehicle as an air-filter device in an air-conditioning assembly or as an engine filter device, having a filter unit with a filter housing and a filter insert comprising a filter frame and a filter element. In addition, there is a transponder. Transponders in label form can be stuck onto the filter insert, preferably the filter frame, in a simple manner like a label. The transponder can be designed as an RFID transponder (RFID=radio frequency identification), in particular as a passive RFID transponder.

Owing to the limited inclusion of safety-relevant data from the air-dryer unit, e.g. the specific state of usage thereof even before it is mounted on an air-treatment unit associated therewith, there are always certain gaps in the safety of air-treatment units known in the prior art.

It is the object of the present invention to further develop a system comprising an air-dryer unit for an air-treatment unit of the type stated at the outset in an advantageous manner, in particular in such a way that the reliability of identification and security against counterfeiting of the system are improved.

According to the invention, this object is achieved by a system having the features of claim 1. According to this, it is envisaged that an air-treatment system for a utility vehicle has at least one air-treatment unit and at least one air-dryer cartridge detachably screwed onto the air-treatment unit, wherein the air-dryer cartridge has on its outer side an identification element and the air-treatment unit has a counterpart for the identification element, and wherein, in the assembled position, the identification element and the counterpart for the identification element are arranged substantially in a direct line-of-sight connection.

The invention is based on the fundamental concept that an air-dryer cartridge can be identified by means of an identification element and that this can be checked with little effort by means of the non-exchangeable part of the air-treatment system, namely by means of the air-treatment unit. Thus, it is an essential aim of the invention to check whether the screwed-on air-dryer cartridge is an original cartridge and whether the service life or actual state of usage thereof can be identified. It is likewise conceivable to check whether the cartridge is in a new condition or whether the cartridge has already been reconditioned one or more times. This checking can take place automatically. In principle, it is also conceivable for it to take place continuously or online. It is conceivable to use optical, electronic or other principles of action as identification methods. In particular, checks of this kind can be carried out in a wired or wireless manner. In this context, a wireless Bluetooth connection, in particular, offers a very simple and effective option for connection and checking. Wireless Wi-Fi connections are also conceivable in this context. Wired checking technologies are likewise conceivable and advantageous, in particular because of their low-cost implementation.

The abovementioned information on the characteristics of the cartridge can be stored in the identification element and correspondingly read out by the counterpart. In this context, each cartridge can be given a unique and encrypted identification code, which can be stored in the counterpart and checked by means of the latter. In the case of reconditioning, the service life information can furthermore only be reset if the identification code is known or input, said identification code giving an individual cartridge a unique associated identity. Moreover, this code can include the fact that this cartridge has actually also been sold by an authorized specialist dealer, and corresponding invoice data can be stored in the code. Server-based or database-based checking of this code is also conceivable, for which purpose the air-treatment unit has a corresponding communications infrastructure in order to communicate with these servers or databases, and the corresponding identification codes are stored in and can be called up from the database. Moreover, this server-based solution can be used to check automatically whether an identification code has been used more than once or is associated with several cartridges, as a result of which an error signal is sent to the relevant air-treatment unit and, for example, continued operation of the vehicle is no longer authorized. For this purpose, however, the system can additionally use GPS data that can be called up by the vehicle to identify a suitable location for blocking continued operation (e.g. in a rest area or parking area and the like).

In order to allow unhindered identification, a direct line-of-sight connection should be provided. This facilitates optical and/or electronic checking. A direct line-of-sight connection of this kind is formed in the assembled state by direct, opposite and/or mutually aligned arrangement of the identification element and the counterpart. In other words, there is only a gap containing ambient medium of the air-treatment system, generally consisting of ambient air, between the identification element and the counterpart. Consequently, there are, in particular, no other components, such as housing parts, connections or lines arranged between the identification element and the counterpart that could negatively affect such a line-of-sight connection and the resulting reliability of identification. Moreover, a direct line-of-sight connection has a minimum spacing between the identification element and the counterpart, thus enabling the reliability of identification and the quality of identification to be further improved. In addition, provision can be made for the identification element and the counterpart to have a certain degree of projected-area overlap in relation to a central axis of the spacing in the assembled state. Such a degree of overlap can be between about 20% and 100%. Other or smaller degrees of overlap are likewise conceivable.

As an alternative, the abovementioned reliable communication, identification or checking can also take place when the counterpart and the identification element do not overlap. Here, for example, the identification element could be arranged on the outside of the air-dryer cartridge, 180° diametrically opposite the counterpart, with all intermediate arrangements in this respect likewise being conceivable. In this case, the identification or communication would take place at least in part through the substantially circular housing structure of the air-dryer cartridge, which would entail a simplification of the assembly process. Provision can furthermore be made for the identification element to be arranged on a dome of the housing of the air-dryer cartridge and, in particular, to be arranged centrally on the dome.

It is conceivable that the air-treatment unit can have a fastening thread for the air-dryer cartridge, in particular for fastening the air-dryer cartridge, wherein the fastening thread has a thread start with a defined position and/or angular position, and the air-dryer cartridge can have a thread, which can be brought into engagement with the fastening thread of the air-treatment unit, in particular in order to fasten the air-dryer cartridge on the air-treatment unit, and which has a thread start with a defined position and/or angular position. By virtue of the mutually corresponding thread starts of the fastening thread of the air-treatment unit and of the thread of the air-dryer cartridge, the air-dryer cartridge can be fastenable or fastened on the air-treatment unit in a defined position and/or angular position in relation to the air-treatment unit. This can take place, for example, with a view to the line-of-sight connection between the identification element and the counterpart for the identification element, and/or can be configured for this purpose.

It is furthermore conceivable that the identification element can be arranged in such a way in relation to the thread start of the air-dryer cartridge that the identification element is situated in an angular range of ±30 degrees with respect to the counterpart when the air-dryer cartridge has been screw-fastened onto the air-treatment unit, in particular with a prescribed torque. A prescribed torque can be any suitable torque to fasten an air-dryer cartridge on an air-treatment unit. In particular, screw-fastened can mean that the air-dryer cartridge is situated in a final screwed position on the air-treatment unit, in which correct operation of the air-dryer cartridge, of the air-treatment unit and/or of the air-treatment system can be carried out. By virtue of the specific configuration of the above-described thread and of the arrangement of the identification element, the process of achieving the defined end position and thus the direct line-of-sight connection between the identification element and the counterpart is made easier and enabled even during the assembly process itself. Furthermore, said angular range can refer, for example, to an orthogonal line which starts from the counterpart and extends substantially in the direction of an or the air-dryer cartridge. It is likewise conceivable for the angular range to be less than ±30 degrees, e.g. ±25 degrees, ±20 degrees, ±15 degrees, ±10 degrees or ±5 degrees, or to be greater than ±30 degrees, e.g. ±35 degrees, as long as the direct line-of-sight connection is maintained.

In particular, it is conceivable for the identification element to be an RFID chip. It is also conceivable for the corresponding counterpart likewise to be an RFID chip or an RFID reader. The direct line-of-sight connection makes possible problem-free mutual checking of the identification element and the corresponding counterpart.

Moreover, provision can be made for the air-treatment unit to have a base element and a housing element, which rises from the base element, wherein, in the assembled state, the housing element is arranged parallel to and in a direct line-of-sight connection with the air-dryer cartridge. The air-dryer cartridge can be screwed onto the base element. Thus, the base element can form a kind of bottom element from which the housing element and the air-dryer cartridge each extend in corresponding fashion in the same direction in the assembled state, i.e. they rise in parallel from the base element. This is a simple and reliable way of enabling a line-of-sight connection, i.e. a direct line of sight. Alternatively or in addition, provision can be made for the air-dryer cartridge to have an identification element on its underside in the assembled state and for the base to have a counterpart for the identification element, wherein the identification element and the counterpart for the identification element are likewise arranged in a direct line-of-sight connection. In particular, this arrangement has the advantage of a very short distance between the identification element and the base, thus increasing the reliability of checking and communication. Moreover, in the assembled state, this arrangement is very difficult to access from the outside, and therefore increased protection and more difficult accessibility to ensure protection from unauthorized actions on the base and/or the cartridge is prevented.

The counterpart can be arranged in the housing element. It is thereby made possible to ensure the direct line-of-sight connection in a simple and reliable manner. In particular, it is conceivable for the counterpart and also the identification element to be arranged in the housing element and in the air-dryer cartridge, respectively, in such a way that, in the assembled state, they are at substantially the same distance from the base element.

A viewing window can be arranged in the housing, in the housing element for the counterpart. This ensures, for example, that metal housing elements or other elements or wall parts of the housing element do not prevent data transmission between the identification element and the counterpart or corresponding communication between the identification element and the counterpart. This may also be advantageous in the case of optical transmission methods.

It is conceivable, in particular, that data exchange between the identification element and the corresponding counterpart can take place precisely in the case of electronic solutions. This can be accomplished by means of radio waves, magnetic waves or the like. Electric fields may also be used.

The counterpart can be arranged on an electronic circuit board in the air-treatment unit. This is advantageous particularly in the case of electronic solutions, including when RFID technology is used, since it is possible, for example, in this case to make direct use of the electronic circuit board of the air-treatment unit and for the information arriving in the counterpart to be further processed directly by the control electronics of the air-treatment unit.

Moreover, provision can be made for the air-dryer cartridge and the base element to be sealed with respect to one another by means of a radial seal. The radial seal makes it possible to enable a defined position of the air-dryer cartridge with respect to the base element and thus also, for example, with respect to the housing element. In contrast to other solutions, radial sealing solutions make it possible to provide a corresponding sealing effect in a simpler way, although just one defined fastening movement is required. In this context, it is conceivable to make clear, by appropriate configuration of a thread (e.g. of the above-described thread) or of a bayonet catch, that the appropriate retention force and also sealing force for the buildup of the necessary sealing effect is achieved by means of a quarter turn or a three-quarter turn or a single turn, and therefore it is possible, by the screw-on process itself, also to determine the defined end position of the identification element on the air-dryer cartridge to be installed relative to the housing element or base. It is thereby made easier and made possible, during the assembly process itself, to achieve the defined end position and thus the direct line-of-sight connection between the identification element and the counterpart. In particular, the thread (e.g. the above-described thread) or bayonet catch can be configured in such a way that the defined end position between the identification element and the counterpart allows the above-described degree of overlap, thus making it possible to achieve a further improvement in its functioning. Such overlaps are achieved essentially by means of an angle of rotation between the air-dryer cartridge and the base. Such angles can be within a range of 30°, as already described. In this context, both the cartridge and the base element have an end position indication, which align with one another in the assembled state and thus clearly define the end position. By means of this indication, clear and virtually error-free determination of the desired assembly position for the defined end position can be provided. In addition or as an alternative, the base and/or the air-dryer cartridge can have a rotation stop, which prevents further rotation between these two elements and thus likewise clearly defines the end position. A precise end position can also be achieved by means of a defined tightening torque.

In particular, the radial seal can serve as a sealing interface for sealing between the air-dryer cartridge and the base element. In this case, the sealing interface has a sealing element, a sheet metal element on the air-dryer-cartridge side and a base-side extension. In this case, the base-side extension furthermore has a bearing surface for the sealing element which is oriented radially inward in relation to the longitudinal axis of the base element and of the air-dryer cartridge. The sheet metal element in turn is fastened on the air-dryer-cartridge side, and therefore the sealing element is pressed against the bearing surface in the assembled state. Moreover, the sealing interface has a holding element, which, in the assembled state, is arranged in such a way that the sealing element is held at least partially in the axial and/or radial direction in relation to the longitudinal axis between the sheet metal element and the bearing surface by means of the sheet metal element and/or the holding element.

### DETAILED DESCRIPTION OF THE DRAWINGS

The single FIGURE shows schematically an exemplary embodiment of an air-treatment system for a utility vehicle according to the present invention.

The air-treatment system 10 is an air-treatment system 10 for a utility vehicle.

It comprises an air-treatment unit 12 and an air-dryer cartridge 14.

In this case, the air-dryer cartridge 14 can be screwed detachably onto the air-treatment unit 12 and is screwed on there in the assembled state.

For this purpose, the air-treatment unit 12 furthermore has a base element 16 and a housing element 18, which rises from the base element 16.

In the assembled state, the housing element 18 is arranged parallel to and in a direct line-of-sight connection with the air-dryer cartridge 14.

An RFID tag or RFID chip 20 is arranged on the outside of the air-dryer cartridge 14.

An RFID chip 22 is arranged as a counterpart in the housing element 18 of the air-treatment unit 12.

A line-of-sight connection of this kind is formed in the assembled state by direct, opposite and/or mutually aligned arrangement of the identification element and the counterpart.

Between the identification element and the counterpart there is only a gap containing ambient medium of the air-treatment system 10, which generally consists of ambient air.

Consequently, there are, in particular, no other components, such as housing parts, connections or lines arranged between the identification element and the counterpart that could negatively affect such a line-of-sight connection and the resulting reliability of identification.

Moreover, a direct line-of-sight connection has a minimum spacing between the identification element and the counterpart.

In addition, provision can be made for the identification element and the counterpart to have a certain degree of projected-area overlap in relation to a central axis of the spacing in the assembled state.

Such a degree of overlap can be between about 20% and 100%. Other, smaller degrees of overlap are likewise conceivable.

In this case, the RFID chip 22 of the air-treatment unit 12 is fastened to the electronic circuit board 24, which is situated in the housing element 18.

To ensure the direct line-of-sight connection, a viewing window 28 is provided in the wall 26 of the housing element 18, and therefore the RFID tag 20 of the air-dryer cartridge 14 can communicate unhindered with the RFID chip 22 of the air-treatment unit 12.

In this case, the air-dryer cartridge 14 is screwed onto the base element 16 by means of a radial seal. A corresponding defined end position for the air-dryer cartridge 14 is thereby already determined in advance as it is screwed onto the base element 16.

For this purpose, screw-on markings (not shown) can be provided both on the air-dryer cartridge 14 and on the base element 16, thus ensuring the direct line-of-sight connection between the RFID tag 20 of the air-dryer cartridge 14 and the RFID chip 22 and the viewing window 28 during the screw-fastening process.

In particular, for this purpose the air-treatment unit 12 can have a fastening thread for the air-dryer cartridge 14, e.g. on the base element 16, wherein the fastening thread has a thread start with a defined position and/or angular position, and the air-dryer cartridge 14 can have a thread, which can be brought into engagement with the fastening thread of the air-treatment unit 12 and which has a thread start with a defined position and/or angular position.

In this case, the RFID tag 20 can be arranged in such a way in relation to the thread start of the air-dryer cartridge 14 that the RFID tag 20 is in an angular range of ±30 degrees with respect to the RFID chip 22 when the air-dryer cartridge 14 has been screw-fastened to the air-treatment unit 12, in particular the base element 16.

In particular, a corresponding defined end position for the air-dryer cartridge 14 is thereby already determined in advance as it is screwed onto the base element 16.

Also visible in the single FIGURE is the main compressor 30, the compressed-air inlet 32, the bleed valve 34 situated in the base element 16, the muffler 36 for the compressed-air bleed from the base element 16, a first solenoid valve 38 and a second solenoid valve 40, which are used to control air treatment and are arranged in the housing element 18.

As can furthermore be seen, two check valves 42 are likewise provided in the housing element 18.

In addition, an electrical connection plug 44 for the air-treatment system is provided on the housing element 18, said plug likewise projecting through the metal housing wall 26 of the housing element 18.

In this case, the electric connection plug 44 is connected to the circuit board 24, which can be a printed circuit board (PCB).

Also provided on the printed circuit board 44 is a microcontroller 46, which is depicted in the conventional manner.

### LIST OF REFERENCE SIGNS

10 air-treatment system
12 air-treatment unit
14 air-dryer cartridge
16 base element
18 housing element
20 RFID tag
22 RFID chip
24 electronic circuit board
26 wall
28 viewing window
30 main compressor
32 compressed-air inlet
34 bleed valve
36 muffler
38 solenoid valve
40 solenoid valve
42 check valve
44 connection plug
46 microcontroller

1.-9. (canceled)

10. An air-treatment system for a utility vehicle, comprising at least one air-treatment unit and at least one air-dryer cartridge, detachably screwed onto the air-treatment unit, wherein the air-dryer cartridge has an identification element on an outer side of the air-dryer cartridge and the air-treatment unit has a counterpart for the identification element wherein, in the assembled position, the identification element and the counterpart for the identification element are arranged substantially in a line-of-sight connection.

11. The air-treatment system according to claim 10, wherein the air-treatment unit has a fastening thread for the air-dryer cartridge, wherein the fastening thread has a thread start with at least one of a defined position and an angular position, and the air-dryer cartridge has a thread, which can be brought into engagement with the fastening thread of the air-treatment unit and which has a thread start with at least one of a defined position and an angular position.

12. The air-treatment system according to claim 11, wherein the identification element is arranged in such a way, in relation to the thread start of the air-dryer cartridge, that the identification element is situated in an angular range between negative thirty degrees and positive thirty degrees with respect to the counterpart when the air-dryer cartridge has been screw-fastened onto the air-treatment unit.

13. The air-treatment system according to claim 11, wherein the identification element is arranged in substantially a line-of-sight connection with the counterpart upon application of a prescribed torque.

14. The air-treatment system according to claim 10, wherein the identification element is an RFID chip.

15. The air-treatment system according to claim 10, wherein the air-treatment unit has a base element and a housing element, which rises from the base element, wherein, in the assembled state, the housing element is arranged parallel to and in a line-of-sight connection with the air-dryer cartridge.

16. The air-treatment system according to claim 15, wherein the counterpart is arranged in the housing element.

17. The air-treatment system according to claim 15, wherein a viewing window is arranged in the housing, in the housing element for the counterpart.

18. The air-treatment system according to claim 17, wherein the counterpart is an optical sensor.

19. The air-treatment system according to claim 10, wherein the counterpart is arranged on an electronic circuit board in the air-treatment unit.

20. The air-treatment system according to claim 10, wherein the air-dryer cartridge and the base element are sealed with respect to one another by means of a radial seal.

21. A method of aligning for assembly of an air-treatment cartridge with an air-treatment unit, comprising affixing at a prescribed torque the air-treatment cartridge onto the air-treatment unit such that an identification element on an air-treatment cartridge is substantially in a line-of-sight connection with a counterpart on the air-treatment unit, wherein a fastening thread on the air-treatment unit has a thread start with at least one of a defined position and an angular position, and the air-treatment cartridge has a thread, which can be brought into engagement with the fastening thread of the air-treatment unit and which has a thread start with at least one of a defined position and an angular position

22. An apparatus for air-treatment of a utility vehicle, comprising at least one air-treatment unit and at least one air-dryer cartridge, detachably screwed onto the air-treatment unit, wherein the air-dryer cartridge has an identification element on an outer side of the air-dryer cartridge and the air-treatment unit has a counterpart for the identification element wherein, in the assembled position, the identification element and the counterpart for the identification element are arranged substantially in a direct line-of-sight connection.
